(19) United States
(12) Patent Application Publication
(10) Pub. No.: US 2015/0251792 A1
(43) Pub. Date: Sep. 10, 2015

(54) METHOD FOR CHANGING THE PRE-STRETCH LEVEL OF A STRETCH-FILM WRAPPING MACHINE, PRE-STRETCHING DEVICE FOR A STRETCH-FILM WRAPPING MACHINE, STRETCH-FILM WRAPPING MACHINE, AND GEARBOX FOR A PRE-STRETCHING DEVICE

(71) Applicant: Signode Industrial Group LLC, Glenview, IL (US)

(72) Inventors: Janne Koskela, Turku (FI); Joonas Jarvinen, Turku (FI)

(21) Appl. No.: 14/431,633

(22) PCT Filed: Aug. 26, 2013
(86) PCT No.: PCT/US2013/056633

§ 371 Date: Mar. 26, 2015

(30) Foreign Application Priority Data
Oct. 5, 2012 (FI) 20126039

(51) Int. Cl. B65B 65/02; B65B 11/00; F16H 57/00; B65B 61/00

(52) U.S. Cl. CPC B65B 65/02; B65B 61/00; B65B 11/00; F16H 57/0018; B65B 2011/002

(57) ABSTRACT

Various embodiments of the present disclosure provide a pre-stretching device for a stretch-film wrapping machine that enables quick and easy modification of the pre-stretch level. Specifically, in various embodiments, the two power transmission gears that control the rotation of the two pre-stretch rollers (and thus the pre-stretch level) are located outside of the housing of the pre-stretching device. This enables an operator to easily access those gears when the operator desires to swap those gears with a set having a different transmission ratio (and thus corresponding to a different pre-stretch level).

### PRIORITY CLAIM

This application is a national stage entry of PCT/US2013/056633, filed on Aug. 26, 2013, which claims priority to and the benefit of Finland Patent Application No. 20126039, filed on Oct. 5, 2012, the entire contents of each of which are incorporated herein by reference.

### FIELD

The present disclosure relates to changing the pre-stretch level of a plastic stretch-film used to wrap palletized loads or articles with a stretch-film wrapping machine. More precisely the present disclosure relates to a method for changing the pre-stretch level of a stretch-film by changing the transmission ratio between the first pre-stretching roller and the second pre-stretching roller of the pre-stretching device of the wrapping machine, and to such a pre-stretching device. The present disclosure also relates to a stretch-film wrapping machine equipped with such a pre-stretching device, and to a gearbox for such a pre-stretching device.

### BACKGROUND

When a palletized load and articles are wrapped in a plastic stretch-film, the film is usually pre-stretched to a certain degree prior to wrapping the film around the load. The stretched film provides secure protection of the wrapped load and helps to keep the wrapped products at their places on the pallet. The stretching of the film also lowers the thickness of the film and thus less film material is used in the wrapping of the load.

Normally the pre-stretching of a film in a wrapping machine is carried out in the pre-stretching device of the wrapping machine, such as a film carriage, into which device a roll of plastic wrapping film is inserted. Depending on the construction of the wrapping machine, the pre-stretching device can be stationary in relation to the load to be wrapped, or the pre-stretching device can be movable in relation to the load to be wrapped. The pre-stretching device generally comprises two pre-stretching rollers, which rollers are rotated at different rotating speeds in order to obtain desired level of pre-stretching to the film prior to wrapping the film on the load to be wrapped. The two pre-stretching rollers are coupled to each other via transmission gears. Publication EP 1 542 192, for example, discloses this type of a known wrapping machine having a pre-stretching device configured to pre-stretch a film web drawn from a film roll before its being wrapped around an object, where the pre-stretching device comprises a first pre-stretching roller and a second pre-stretching roller, which rollers are tractively coupled via power transmission gears.

Changing of the pre-stretch level of the film to be wrapped is required since different types of wrapping films endure different amounts of pre-stretching. And since the pre-stretch level is kept close to the maximum for each type of wrapping film in order to save wrapping material, the pre-stretch level need to be adjusted when the type of the wrapping film is changed.

The changing of the pre-stretch level of the film in these types of known stretch-film wrapping machines generally required at least partial dismantling of the pre-stretching device in order to change the transmission ratio of the two pre-stretching rollers by changing the power transmission gears coupling the rollers. This action generally takes about 1-2 hours and thus causes significant downtime to the wrapping machine.

Another known solution for changing the pre-stretch level of the film in stretch-film wrapping machine is to equip both of the pre-stretch rollers with separate motors. This way the pre-stretch level of the film can be changed by adjusting the rotating speeds of the motors. These types of arrangements however provide more complex and costly construction of the pre-stretching device of the wrapping machine.

Publication GB 2 395 165 discloses a pre-stretching device for use in pre-stretching plastic wrapping film, where the transmission ratio between the two pre-stretching rollers can be changed without removing and replacing the relating gears. In this arrangement each roller has at least two coaxially mounted gear wheels coupled to the roller, one of these gear wheels on each roller is fixed for rotation with the roller and the other gear wheel is mounted for non-fixed free rotation relative to the roller. The arrangement also comprises coupling means for selectively coupling a fixed gear wheel to a non-fixed gear wheel on one or other roller in order to change the pre-stretch level of the device. This arrangement also provides complex and thus costly construction of the pre-stretching device of the wrapping machine.

Publication EP 0 653 352 discloses an incrementally variable transmission between pre-stretching rollers in a stretch-film wrapping machine. In this arrangement pre-stretching rollers are coupled via a reduction gear and a transmission unit with variable transmission ratios. The required reduction gear and transmission unit makes the construction of a pre-stretching device according to this arrangement complex and thus costly.

### SUMMARY

The present disclosure provides a simple and cost effective arrangement for changing the pre-stretch level of a pre-stretch wrapping machine, where the change of the pre-stretch level can be carried out quickly and easily. The present disclosure also provides reliable and stable arrangement for changing the pre-stretch level of a pre-stretch wrapping machine, where the changing of the pre-stretch level can be carried out without tools and dismantling of the machinery and without any special technical knowledge so that anyone can carry out the changing process.

In the present disclosure the pre-stretch level of the stretch-film wrapping machine is changed by replacing the power transmission gears coupling the first and second roller located on an outer surface of the pre-stretching device. Since the power transmission gears in the present disclosure are located on the outer surface of the pre-stretching device, and not inside the construction of the pre-stretching device as in the prior-art devices, the power transmission gears are easily accessible and can be quickly changed to another set of transmission gears providing different transmission ratio and thus different level of pre-stretching of the film.

The pre-stretching device according to the present disclosure comprises a first pre-stretching roller and a second pre-stretching roller, which rollers are substantially parallel and comprise parallel rotating shafts for rotating the rollers, which rotating shafts are coupled to each other with power transmission gears. The ends of the rotating shafts extend through an outer surface of the pre-stretching device and the power transmission gears are connected at the portions of shafts extending from the surface of the pre-stretching device.

The transmission gears are advantageously connected to the shafts of the pre-stressing rollers with mating cross-sectional forms so that the ends of the shafts of the pre-stretching rollers have cross-sectional forms that deviate from circle, and the respective gears have center holes corresponding to the cross-sectional forms of the respective ends of the shafts for connecting respective gears to respective shafts. This way the replacement of the gears can be easily carried out simply by pulling the first transmission gears away from the ends of the shafts and pushing second transmission gears on the ends of the shafts, in the length direction of the shafts.

The power transmission gears are advantageously located in a separate housing, which housing is connected detachably to the pre-stretching device through the connection between the power transmission gears and the ends of the shafts of the pre-stretching rollers. This way the different sets of power transmission gears can be assembled in different housings for obtaining different transmission ratios, and thus different pre-stretching levels for the pre-stretching device, whereby the change of the pre-stretching level is achieved simply by replacing the whole transmission housing.

The proper positioning of the housing with gears can advantageously be achieved with mating forms or surfaces, where the form of the housing fits is a respective mating form or surface of the pre-stretching device and/or another part of the wrapping machine. This helps with the changing of the gears and in proper alignment of the gears in relation with the ends of the shafts of the pre-stretching rollers.

Advantageously the power transmission gears in certain embodiments of the present disclosure consist of only two intermeshing gears, which are connected to respective ends of the shafts of the pre-stretching rollers. Thus different sets with different transmission ratios can be manufactured cost-effectively.

The present disclosure also provides a stretch-film wrapping machine, which is equipped with a pre-stretching device according to the present disclosure.

Further, the present disclosure also provides a detachable gearbox for a pre-stretching device of a stretch-film wrapping machine, where the power transmission gears are located inside the gearbox, wherein the outer surface of the gearbox comprises at least one hole, and in certain embodiments two holes, for inserting two parallel ends of shafts of pre-stretching rollers of the pre-stretching device, and the power transmission gears comprise two gears equipped with means for connecting the gears to the parallel ends of the shafts of the pre-stretching rollers, which means are located substantially in the areas of the respective holes of the housing. This type of detachable gearbox be easily and quickly attached and detached from the pre-stretching device for changing the pre-stretching level of the wrapping machine, and plurality of gearboxes with different preset transmission ratios can be provided for different pre-stretch levels.

In a detachable gearbox according to the present disclosure, the means for connecting the gears to the parallel ends of the shafts of the pre-stretching rollers advantageously consist of center holes in the two gears, which center holes have cross-sectional form that deviates from circle and which cross-sectional form fits to corresponding cross-sectional form of the parallel ends of the shafts of the pre-stretching rollers. This enables the attachment and detachment of the gearbox by simply moving the gearbox in the direction of the shafts of the pre-stretching rollers. Thus the detachable gearbox according to the present disclosure can be changed to another without use of tools or without dismantling of the machinery when the pre-stretch level of the wrapping machine needs to be changed. Therefore anyone can carry out the changing process.

The power transmission gears of the detachable gearbox according to the present disclosure advantageously consist of two intermeshing gears. Thus the construction of the gear box is very simple and cost-effective.

### BRIEF DESCRIPTION OF THE FIGURES

Exemplifying embodiments of the present disclosure and their advantages are explained in greater detail below in the sense of examples and with reference to attached drawings.

FIG. 1A shows an upper portion of a film carriage utilizing the gearbox of the present disclosure.

FIG. 1B shows enlargement A of FIG. 1A showing the pair of gears defining the pre-stretching level of the wrapping machine.

FIG. 2 shows schematically a cross-section of a detachable gearbox of the present disclosure.

### DETAILED DESCRIPTION

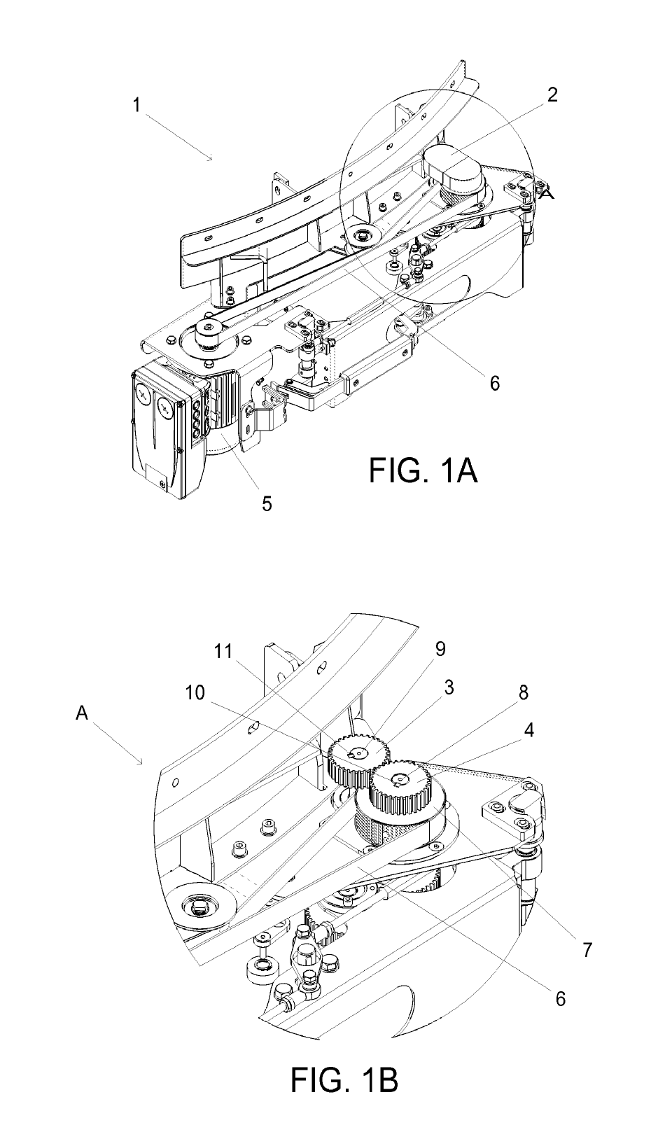

FIG. 1A shows an upper portion of a film carriage 1 of a rotating ring wrapping machine, where the film carriage is connected fixedly to the rotating ring of the wrapping machine in order to rotate the film carriage around the load to be wrapped.

FIG. 1B shows enlargement A of FIG. 1A where the casing 2 is removed in order to show gear pair formed of gears 3 and 4.

In the embodiment of FIGS. 1A and 1B, an electric motor 5 rotates first and second pre-stretching rollers through a belt 6 and belt pulley 7. The belt pulley 7 in connected to the shaft 8 of the first pre-stretching roller, which shaft 8 extends from the upper end of the first pre-stretching roller. Above the belt pulley 7 and on the top end of the shaft 8 of the first pre-stretching roller is gear 4, which gear 4 is connected through a gear coupling to the gear 3, which gear 3 is located on the top end of the shaft 9 of the second pre-stretching roller. The shaft 9 extends from the upper end of the second pre-stretching roller.

In this embodiment the pre-stretch level of the film to be wrapped is defined by the transmission ratio of the gear coupling formed by gears 3 and 4, and the pre-stretch level of the wrapping machine is adjusted and controlled by changing the transmission ratio by changing both of the gears 3 and 4.

The changing of the gears 3 and 4 are done simply by lifting the gears 3 and 4, advantageously simultaneously, upwards in the direction of the upper ends of the shafts 8 and 9 until these gears slide off from the ends of these shafts. Then new pair of gears, again advantageously simultaneously, can be slid on the ends of the shafts 8 and 9. In this embodiment, protrusions 10 and 11 on the outer surfaces of the ends of the shafts 8 and 9, or alternatively on the inner surfaces of the gears 3 and 4, are positioned in the corresponding grooves in the inner surfaces of the gears 3 and 4, or alternately in the outer surfaces of the ends of the shafts 8 and 9, in order to rotate the shafts 8 and 9 together with gears 3 and 4.

The gear pair formed of gears 3 and 4 is advantageously located inside casing 2. This way the gear pair can be replaced simply by replacing the whole casing 2. Further, different casings 2 with different gear pairs 3 and 4 defining different pre-stretching levels for the wrapping machine can be provided for quick changing of the pre-stretch level.

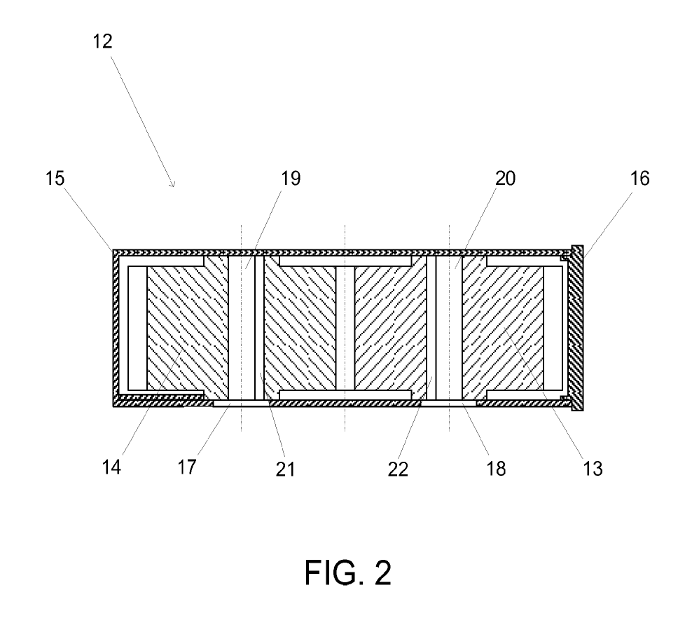

FIG. 2 shows a schematic cross-section of a gearbox 12 according to the present disclosure, comprising a pair of intermeshing gears 13 and 14 inside housing 15.

The housing 15 has detachable end surface 16, which can be detached for changing the pair of gears 13 and 14 inside the gearbox 12. At the lower surface of the housing 15 is provided two holes 17 and 18, which holes are located in the area of the center holes 19 and 20 of the gears 13 and 14. The holes 17 and 18 of the housing 15 are substantially larger than the center holes 19 and 20 of the gears 13 and 14, and the holes 17 and 18 have substantially same center axis than the respective center holes 19 and 20, so that ends of the rotating shafts of the pre-stretching rollers can be inserted through the holes of the housing into the center holes of the gears.

Instead of the two holes 17 and 18 provided in the housing 15, the access to the center holes 19 and 20 of the gears 13 and 14 can be provided with a single hole covering both of the center holes. In that kind of embodiment enough of the lower surface of the casing 15 needs to be maintained so that the gears 13 and 14 are retained inside the casing when the gearbox 2 is slid off the ends of the rotating shafts of the pre-stretching rollers.

FIG. 2 also shows grooves 21 and 22 formed in the inner surface of the center holes 19 and 20 of the gears 13 and 14. The grooves 21 and 22 are utilized when connecting ends of the rotating shafts of the pre-stretching rollers unrotatably to the gears 13 and 14 in a way evident to a person skilled in the art.

Inner surfaces of the housing 15 of the gearbox 12 are advantageously provided with protrusions that guide the gears 13 and 14 to their proper places inside the housing. The housing 15 is advantageously made from plastic.

The specific example provided in the description given above should not be construed as limiting. Various changes and modifications to the present embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1-10. (canceled)

11. A pre-stretching device for a stretch-film wrapping machine, the pre-stretching device comprising:
a housing having an interior;
a first pre-stretching roller including a rotatable first shaft extending from the interior of the housing to outside of the housing;
a first gear removably attached to a portion of the first shaft outside the housing;
a second pre-stretching roller including a rotatable second shaft that is substantially parallel to the first shaft and that extends from the interior of the housing to outside of the housing; and
a second gear removably attached to a portion of the second shaft outside the housing.

12. The pre-stretching device of claim 11, wherein an end of the portion of the first shaft outside the housing has a first non-circular cross section, and the first gear defines a bore therethrough having a first bore cross-section corresponding to the first non-circular cross section to enable attachment of the first gear to the portion of the first shaft outside the housing.

13. The pre-stretching device of claim 12, wherein an end of the portion of the second shaft outside the housing has a second non-circular cross section, and the second gear defines a bore therethrough having a second bore cross-section corresponding to the second non-circular cross section to enable attachment of the second gear to the portion of the second shaft outside the housing.

14. The pre-stretching device of claim 11, which includes a gear housing separate from the housing, the first and second gears located within the gear housing.

15. The pre-stretching device of claim 14, wherein the gear housing is attachable to the first and second pre-stretching rollers via attachment of the first gear to the portion of the first shaft outside the housing and via attachment of the second gear to the portion of the second shaft outside the housing.

16. The pre-stretching device of claim 15, wherein the gear housing is removable from the first and second pre-stretching rollers via removal of the first gear from the portion of the first shaft outside the housing and via removal of the second gear from the portion of the second shaft outside the housing.

17. The pre-stretching device of claim 11, wherein the first gear engages the second gear.

18. The pre-stretching device of claim 17, wherein the first gear is a drive gear, the second gear is a driven gear, and the drive gear drives the driven gear.

19. The pre-stretching device of claim 18, which includes a pulley attached to the first shaft, the drive gear being rotatable with and driven by the pulley.

20. A gearbox for a pre-stretching device of a stretch-film wrapping machine, said gearbox comprising:
a housing defining at least one bore therethrough, the at least one bore sized such that a portion a first shaft of a first pre-stretching roller of the pre-stretching device and a portion of a second shaft of a second pre-stretching roller of the pre-stretching device can pass therethrough into an interior of the housing;
a first gear positioned within the interior of the housing and removably attachable to the portion of the first shaft; and
a second gear positioned within the interior of the housing and removably attachable to the portion of the second shaft.

21. The gearbox of claim 20, wherein an end of the portion of the first shaft has a first non-circular cross section, and the first gear defines a bore therethrough having a first bore cross-section corresponding to the first non-circular cross section to enable attachment of the first gear to the portion of the first shaft.

22. The gearbox of claim 21, wherein an end of the portion of the second shaft has a second non-circular cross section, and the second gear defines a bore therethrough having a second bore cross-section corresponding to the second non-circular cross section to enable attachment of the second gear to the portion of the second shaft.

23. The gearbox of claim 20, wherein the at least one bore includes a first bore sized such that the portion of the first shaft can pass therethrough into the interior of the housing and a second bore sized such that the portion of the second shaft can pass therethrough into the interior of the housing.

24. The gearbox of claim 23, wherein the at least one bore includes a single bore sized such that the portion of the first shaft can pass therethrough into the interior of the housing and the portion of the second shaft can pass therethrough into the interior of the housing.

25. The gearbox of claim 20, wherein at least one surface defining the interior of the housing includes at least one protrusion shaped to guide at least one of the first gear and the second gear into a designated position.

26. The gearbox of claim 20, wherein the first gear engages the second gear.

27. The gearbox of claim 26, wherein the first gear is a drive gear, the second gear is a driven gear, and the drive gear drives the driven gear.

28. A method for changing a pre-stretch level of a stretch-film wrapping machine, said method comprising:
stopping rotation of a first drive gear attached to a portion of a first shaft of a first pre-stretching roller extending outside of a housing of a pre-stretching device, which in turn stops rotation of a first driven gear that is attached to a portion of a second shaft of a second pre-stretching roller extending outside of the housing of the pre-stretching device, wherein the first drive gear and the first driven gear have a first transmission ratio;
removing the first drive gear from the portion of the first shaft and the first driven gear from the portion of the second shaft; and
attaching a second drive gear to the portion of the first shaft and a second driven gear to the portion of the second shaft, wherein the second drive gear and the second driven gear have a second transmission ratio different than the first transmission ratio.

29. The method of claim 28, wherein the first drive gear and the first driven gear are housed within a first gearbox, and wherein removing the first drive gear from the portion of the first shaft and the first driven gear from the portion of the second shaft includes substantially simultaneously removing the first drive gear from the portion of the first shaft and the first driven gear from the portion of the second shaft.

30. The method of claim 29, wherein the second drive gear and the second driven gear are housed within a second different gearbox, and wherein attaching the second drive gear to the portion of the first shaft and the second driven gear to the portion of the second shaft includes substantially simultaneously attaching the second drive gear to the portion of the second shaft and the second driven gear to the portion of the second shaft.
